(19) United States
(12) Patent Application Publication
(10) Pub. No.: US 2011/0132730 A1
(43) Pub. Date: Jun. 9, 2011

(54) MOTION SENSOR

(75) Inventors: Megumu Ito, Suwa-shi (JP); Junichiro Shinozaki, Chino-shi (JP)

(73) Assignee: SEIKO EPSON CORPORATION, Shinjuku-ku (JP)

(21) Appl. No.: 12/961,377

(22) Filed: Dec. 6, 2010

(30) Foreign Application Priority Data
Dec. 7, 2009 (JP) 2009-277255

(51) Int. Cl. H01H 35/02

(52) U.S. Cl. 200/61.52

(57) ABSTRACT

A motion sensor includes: a first tilt detector including a first electrode having a recess and a second electrode and a first conductive ball having shape same as that of the first electrode; a second tilt detector including a third electrode having a recess and a fourth electrode and a second conductive ball having shape same as that of the third electrode; and a third tilt detector including a fifth electrode having a recess and a sixth electrode and a third conductive ball having shape same as that of the fifth electrode, wherein in the first tilt detector, the recess of the first electrode and the recess of the second electrode are opposed to each other, the first electrode and the second electrode are arranged to be plane-symmetrical to each other at a first distance with respect to a plane perpendicular to a first axis, and the first conductive ball moves in a space between the first electrode and the second electrode to change the first electrode and the second electrode to a conductive state or a non-conductive state, in the second tilt detector, the recess of the third electrode and the recess of the fourth electrode are opposed to each other, the third electrode and the fourth electrode are arranged to be plane-symmetrical to each other at a second distance with respect to a plane perpendicular to a second axis orthogonal to the first axis, and the second conductive ball moves in a space between the third electrode and the fourth electrode to change the third electrode and the fourth electrode to the conductive state and the non-conductive state, in the third tilt detector, the recess of the fifth electrode and the recess of the sixth electrode are opposed to each other, the fifth electrode and the sixth electrode are arranged to be plane-symmetrical to each other at a third distance with respect to a plane perpendicular to a third axis orthogonal to both the first axis and the second axis, and the third conductive ball moves in a space between the fifth electrode and the sixth electrode to change the fifth electrode and the sixth electrode to the conductive state or the non-conductive state, the first distance is a distance shorter than a diameter of the first conductive ball, the second distance is a distance shorter than a diameter of the second conductive ball, and the third distance is a distance shorter than a diameter of the third conductive ball.

### BACKGROUND

1. Technical Field

The present invention relates to a motion sensor that detects the motion of, for example, a person, an animal, and an object.

2. Related Art

There are various apparatuses that detect the motion of a person, an animal, and an object and use the motion for control. A sensor that is used in such apparatuses and detects the motion of a person, an animal, and an object may be generally called motion sensor. As such a motion sensor, an acceleration sensor, an angular velocity sensor, and the like are used. Depending on a use, plural sensors are used in combination.

For example, JP-A-2009-73492 proposes, as an apparatus used for a motorcycle, an overturning detecting apparatus including a vertical sensor that detects acceleration in a first direction, which is a direction perpendicular to the ground, and a horizontal sensor that detects acceleration in a second direction, which is a direction orthogonal to the first direction.

However, the sensors that detect acceleration can accurately detect variation in motion but always consume electric power. Therefore, although no problem occurs when power supply can be continuously performed as in the motorcycle, it is conceivable a situation in which power supply cannot be continuously performed occurs when the sensors are used for a person and an animal. It is difficult to always use the sensors. If the sensors are used for the purpose of detecting overturning, it is considered that the sensors do not always have to accurately detect acceleration. Therefore, there is a demand for an apparatus including sensors having simpler structure.

### SUMMARY

An advantage of some aspect of the invention is to solve at least a part of the problems described above and can be embodied as the following forms or application examples.

### APPLICATION EXAMPLE 1

According to this application example of the invention, there is provided a motion sensor including: a first tilt detector including a first electrode having a recess and a second electrode and a first conductive ball having shape same as that of the first electrode; a second tilt detector including a third electrode having a recess and a fourth electrode and a second conductive ball having shape same as that of the third electrode; and a third tilt detector including a fifth electrode having a recess and a sixth electrode and a third conductive ball having shape same as that of the fifth electrode. In the first tilt detector, the recess of the first electrode and the recess of the second electrode are opposed to each other, the first electrode and the second electrode are arranged to be plane-symmetrical to each other at a first distance with respect to a plane perpendicular to a first axis, and the first conductive ball moves in a space between the first electrode and the second electrode to change the first electrode and the second electrode to a conductive state or a non-conductive state. In the second tilt detector, the recess of the third electrode and the recess of the fourth electrode are opposed to each other, the third electrode and the fourth electrode are arranged to be plane-symmetrical to each other at a second distance with respect to a plane perpendicular to a second axis orthogonal to the first axis, and the second conductive ball moves in a space between the third electrode and the fourth electrode to change the third electrode and the fourth electrode to the conductive state and the non-conductive state. In the third tilt detector, the recess of the fifth electrode and the recess of the sixth electrode are opposed to each other, the fifth electrode and the sixth electrode are arranged to be plane-symmetrical to each other at a third distance with respect to a plane perpendicular to a third axis orthogonal to both the first axis and the second axis, and the third conductive ball moves in a space between the fifth electrode and the sixth electrode to change the fifth electrode and the sixth electrode to the conductive state or the non-conductive state. The first distance is a distance shorter than the diameter of the first conductive ball, the second distance is a distance shorter than the diameter of the second conductive ball, and the third distance is a distance shorter than the diameter of the third conductive ball.

With this configuration, the motion sensor includes the tilt detector on each of the first axis, the second axis perpendicular to the first axis, and the third axis perpendicular to the first and second axes. Therefore, in a target attached with the motion sensor, it is possible to learn a change in the posture of the target with respect to the three axes orthogonal to one another. The tilt detector has simple structure because the conductive state and the non-conductive state are caused by the pair of electrodes respectively having the recesses opposed to each other and the moving conductive ball present between the pair of electrodes. Therefore, compared with sensors having other kinds of structure, it is possible to reduce size and reduce power consumption. Consequently, even if a plurality of the tilt detectors are included in one motion sensor, it is possible to suppress the size of the motion sensor from increasing and suppress the possibility of insufficiency of power supply. The space in which the moving conductive ball is present is a space formed by the pair of electrodes having the opposed recesses. Therefore, by forming the shape of the recesses of the electrodes to match a target to which the motion sensor is attached or a detection purpose, it is possible to adjust timing for changing to the conductive state and the non-conductive state and easily form the motion sensor according to a use.

Since the distance between the opposed pair of electrodes is set to length smaller than the diameter of the conductive ball, the conductive ball does not extend to the outside of the space formed by the pair of electrodes. Since the pair of electrodes are changed to the conductive state or the non-conductive state, the electrodes are not in contact with each other. In other words, in this application example, the distance between the pair of electrodes is length larger than zero and smaller than the diameter of the conductive ball. Therefore, in this application example, by changing the distance between the pair of electrodes within a range of the length larger than zero and smaller than the diameter of the conductive ball, it is possible to change the size of an angle at which the conductive ball can stay in contact with both the pair of electrodes. Further, in this application example, the diameter of the conductive ball is length larger than the distance between the pair of electrodes and allowing the conductive ball to move in the space formed between the pair of electrodes. By changing the diameter of the conductive ball within this range, it is possible to change the size of the angle at which the conductive ball can stay in contact with both the pair of electrodes. Therefore, by changing one or both of the distance between the pair of electrodes and the diameter of the conductive ball, it is possible to easily perform adjustment of the range of the angle at which the pair of electrodes change to the conductive state and it is possible to easily form a motion sensor according to a use.

### APPLICATION EXAMPLE 2

The motion sensor according to the application example may preferably be configured such that at least one fourth tilt detector is arranged on the first axis or an axis parallel to the first axis, at least one fifth tilt detector is arranged on the second axis or an axis parallel to the second axis, and at least one sixth tilt detector is arranged on the third axis or an axis parallel to the third axis. The fourth tilt detector includes a seventh electrode having a recess and an eighth electrode and a fourth conductive ball having shape same as that of the seventh electrode. The recess of the seventh electrode and the recess of the eighth electrode are opposed to each other, the seventh electrode and the eighth electrode are arranged to be plane-symmetrical to each other at a fourth distance with respect to one plane among arbitrary planes other than the plane perpendicular to the first axis, and the fourth conductive ball moves in a space between the seventh electrode and the eighth electrode to change the seventh electrode and the eighth electrode to the conductive state or the non-conductive state. The fifth tilt detector includes a ninth electrode having a recess and a tenth electrode and a fifth conductive ball having shape same as that of the ninth electrode. The recess of the ninth electrode and the recess of the tenth electrode are opposed to each other, the ninth electrode and the tenth electrode are arranged to be plane-symmetrical to each other at a fifth distance with respect to one plane among arbitrary planes other than the plane perpendicular to the second axis orthogonal to the first axis, and the fifth conductive ball moves in a space between the ninth electrode and the tenth electrode to change the ninth electrode and the tenth electrode to the conductive state or the non-conductive state. The sixth tilt detector includes an eleventh electrode having a recess and a twelfth electrode and a sixth conductive ball having shape same as that of the eleventh electrode. The recess of the eleventh electrode and the recess of the twelfth electrode are opposed to each other, the eleventh electrode and the twelfth electrode are arranged to be plane-symmetrical to each other at a sixth distance with respect to one plane among arbitrary planes other than the plane perpendicular to the third axis orthogonal to both the first axis and the second axis, and the sixth conductive ball moves in a space between the eleventh electrode and the twelfth electrode to change the eleventh electrode and the twelfth electrode to the conductive state or the non-conductive state. The fourth distance is a distance shorter than the diameter of the fourth conductive ball, the fifth distance is a distance shorter than the diameter of the fifth conductive ball, and the sixth distance is a distance shorter than the diameter of the sixth conductive ball.

With this configuration, at least one fourth tilt detector is arranged on the axis parallel to the first axis at an angle different from that of the first tilt detector, at least one fifth tilt detector is arranged on the axis parallel to the second axis at an angle different from that of the second tilt detector, and at least one sixth tilt detector is arranged on the axis parallel to the third axis at an angle different from that of the third tilt detector. Therefore, it is possible to detect a finer change of the posture of the target attached with the motion sensor.

### APPLICATION EXAMPLE 3

The motion sensor according to the application example may preferably be configured such that at least two of the first tilt detector, the second tilt detector, the third tilt detector, the fourth tilt detector, the fifth tilt detector, and the sixth tilt detector are stored in a cylindrical container.

With this configuration, since the plural tilt detectors are stored in the cylindrical container, it is possible to easily mount the tilt detectors in the motion sensor.

### APPLICATION EXAMPLE 4

The motion sensor according to the application example may preferably be configured such that a history of output signals of at least one of the first tilt detector, the second tilt detector, the third tilt detector, the fourth tilt detector, the fifth tilt detector, and the sixth tilt detector is stored.

With this configuration, since the history of at least one tilt detector is stored, even when a change in the posture of the target attached with the motion sensor cannot be sampled on a real time basis, it is possible to analyze a change in the posture of the target based on outputs of at least one tilt detector by reading out the history later. Various methods of sampling output signals of the motion sensor are conceivable. One of the methods is a method of sampling output signals of the motion sensor using radio and monitoring the output signals using a personal computer or the like. However, when the radio is used, it is conceivable that the target attached with the motion sensor performs activity on the outer side of an area where output signals can be sampled. In such a case, if the motion sensor itself stores a history, by reading out the history of the motion sensor later, it is possible to analyze a change in the posture of the target attached with the motion sensor in hours when output signals cannot be sampled on a real time basis.

The number of tilt detectors that stores histories only has to be set according to a state of use. Since a capacity of a memory that can be mounted in the motion sensor is limited, if the number of tilt detectors that gather histories is reduced, time in which histories can be gathered is extended and, if the number of tilt detectors that gather histories is increased, time in which histories can be gathered is shortened.

### APPLICATION EXAMPLE 5

The motion sensor according to the application example may preferably be configured such that, as the history, when the output signals reach a predetermined value, a history of output signals of the first tilt detector, the second tilt detector, the third tilt detector, the fourth tilt detector, the fifth tilt detector, and the sixth tilt detector is stored.

With this configuration, after the output signal reaches the predetermined value, by leaving a history of output signals of all the tilt detectors, it is possible to leave information concerning a change in a state considered to be important. The predetermined value is a value determined according to impact that can be determined as causing serious influence for the target attached with the motion sensor. This makes it possible to leave information for examining appropriate measures against a change in a state considered to be important after the target receives the impact. Information enabling estimation of time when the output signals reach the predetermined value may be left in the history. As the information enabling estimation of the time, a value of a clock, a value of a timer, a value of a counter, and the like are conceivable.

### BRIEF DESCRIPTION OF THE DRAWINGS

The invention will be described with reference to the accompanying drawings, wherein like numbers reference like elements.

FIG. 1 is a diagram showing the logical arrangement of tilt detectors in a motion sensor.

FIG. 2 is a diagram showing an example of a way of arranging the tilt detectors in the motion sensor.

FIG. 3 is a sectional view of the tilt detector.

FIGS. 4A and 4B are diagrams showing states of the tilt detector at the time when an MZ axis of the motion sensor and a Z axis are parallel.

FIG. 5 is a diagram showing states of the tilt detectors at the time when the motion sensor is rotated with the MX axis thereof as an axis of rotation.

FIG. 6 is a diagram showing states of the tilt detectors at the time when the motion sensor is rotated with the MX axis thereof as an axis of rotation.

FIG. 7 is a diagram showing states of the tilt detectors at the time when the motion sensor is rotated with the MX axis thereof as an axis of rotation.

FIGS. 8A to 8B are diagrams showing tilt states at changing points of ON and OFF of a tilt detector.

FIGS. 9A to 9C are diagrams showing tilt states at changing points of ON and OFF of a tilt detector.

FIGS. 10A to 10C are diagrams showing tilt states at changing points of ON and OFF of a tilt detector.

FIG. 11 is a diagram used for explanation of angle detection by a motion sensor.

FIG. 12 is a block diagram of a motion sensor including plural tilt detectors.

### DESCRIPTION OF EXEMPLARY EMBODIMENTS

Exemplary embodiments of the invention are explained below with reference to the accompanying drawings.

### First Embodiment

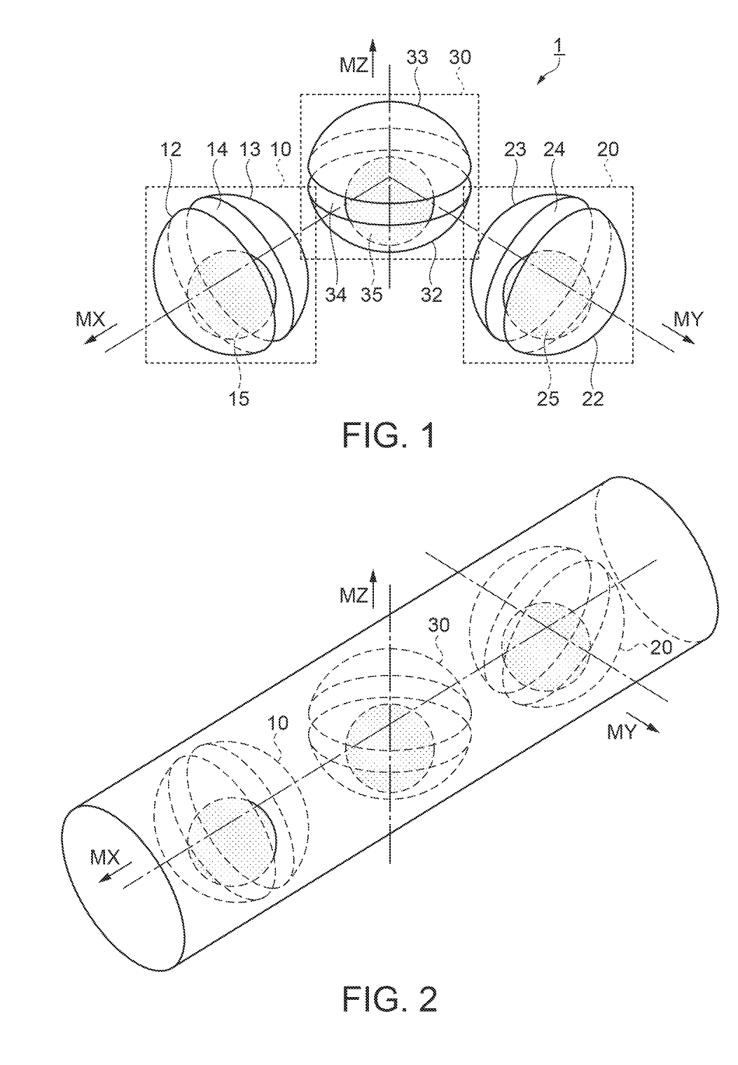

This embodiment is an example of a motion sensor including three tilt detectors that detect tilts with respect to orthogonal three axes (an X axis, a Y axis, and a Z axis). Among the orthogonal three axes, the Z axis is an axis parallel to the gravity direction. A motion sensor 1 in this embodiment is shown in FIG. 1. As shown in FIG. 1, the motion sensor 1 includes a tilt detector 10, a tilt detector 20, and a tilt detector 30. Orthogonal three axes fixed to the motion sensor 1 are an MX axis, an MY axis, and an MZ axis. The motion sensor 1 is attached to a measurement target such that the MX axis, the MY axis, and the MZ axis respectively correspond to the X axis, the Y axis, and the Z axis and the MZ axis is parallel to the Z axis when the motion sensor 1 is attached to the measurement target. An external view of the motion sensor 1 is omitted in FIG. 1. However, the tilt detector 10, the tilt detector 20, and the tilt detector 30 are stored in a predetermined case to configure the motion sensor 1.

The tilt detector 10 includes an electrode 12 having a recess, an electrode 13 having shape same as that of the electrode 12, and a conductive ball 15. The electrode 12 and the electrode 13 are arranged in the motion sensor 1 such that the recesses thereof are opposed to each other to form a space 14 as a moving space of the conductive ball 15 and a plane perpendicular to the MX axis is a symmetrical plane in the electrode 12 and the electrode 13. The tilt detector 20 includes an electrode 22 having a recess, an electrode 23 having shape same as that of the electrode 22, and a conductive ball 25. The electrode 22 and the electrode 23 are arranged in the motion sensor 1 such that the recesses thereof are opposed to each other to form a space 24 as a moving space of the conductive ball 25 and a plane perpendicular to the MY axis is a symmetrical plane in the electrode 22 and the electrode 23. The tilt detector 30 includes an electrode 32 having a recess, an electrode 33 having shape same as that of the electrode 32, and a conductive ball 35. The electrode 32 and the electrode 33 are arranged in the motion sensor 1 such that the recesses thereof are opposed to each other to form a space 34 as a moving space of the conductive ball 35 and a plane perpendicular to the MZ axis is a symmetrical plane in the electrode 32 and the electrode 33. In this embodiment, all the spaces 14, 24, and 34 are spherical spaces.

For convenience of explanation, the tilt detectors 10, 20, and 30 shown in FIG. 1 are respectively arranged on the MX axis, the MY axis, and the MZ axis to clearly show directions in which the tilt detectors 10, 20, and 30 are arranged. However, actually, the tilt detectors 10, 20, and 30 may be arranged in any places as long as the directions are not changed. For example, as shown in FIG. 2, the tilt detectors 10, 20, and 30 may be arranged in a row. When the tilt detectors 10, 20, and 30 are arranged on a printed board, the tilt detectors 10, 20, and 30 may be separately mounted in positions where patterns are easily drawn.

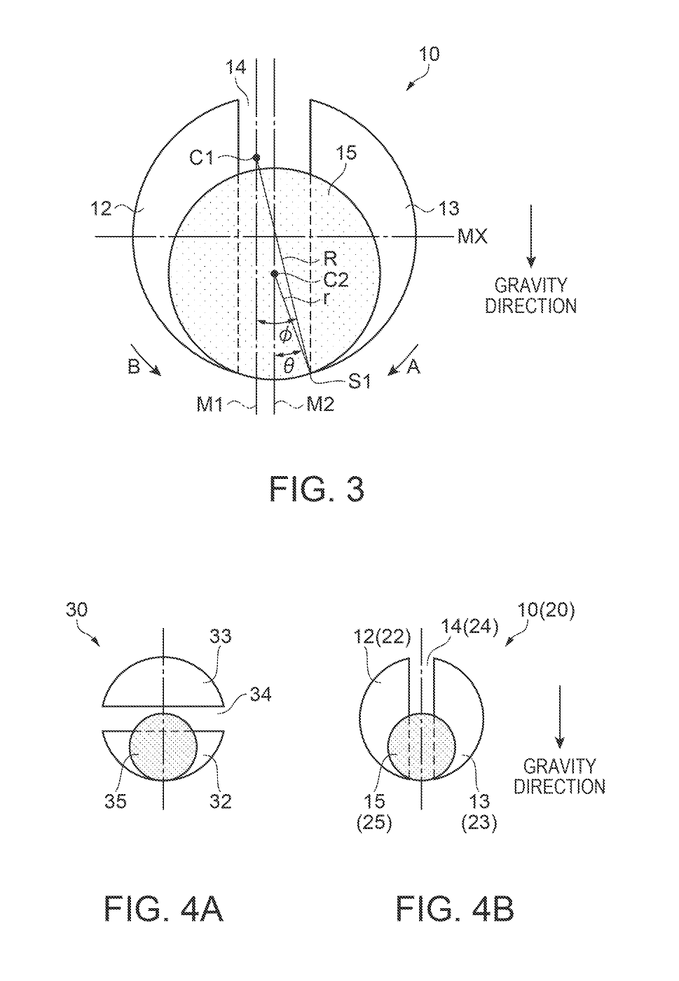

An angle detectable by the tilt detector in this embodiment is explained with reference to FIG. 3. FIG. 3 is a sectional view of the tilt detector 10 on a plane including the MX axis and the MZ axis (not shown). In the tilt detector 10 shown in FIG. 3, the MZ axis is parallel to the Z axis (the gravity direction). In this case, the MX axis is perpendicular to the gravity direction, the conductive ball 15 is in contact with both the electrode 12 and the electrode 13, and the electrode 12 and the electrode 13 are in a conductive state. For convenience of explanation, it is assumed that the MX axis pierces through the center of the tilt detector 10. The MY axis (not shown) is perpendicular to the sectional view in FIG. 3. The tilt detector 10 is in the conductive state. The conductive ball 15 and the electrode 13 are in contact with each other at a point of contact S1. In a state shown in FIG. 3, when a straight line indicating the gravity direction that passes through a center point C1 of a circle, a radius of which is a curvature radius R of the electrode 13 at the point of contact S1, is represented as M1, the size of an angle formed by the straight line M1 and the curvature radius R is represented as Φ. Similarly, in the state shown in FIG. 3, when a straight line indicating the gravity direction that passes through a center point C2 of the conductive ball 15 is represented as M2, the size of an angle formed by the straight line M2 and a radius r of the conductive ball 15 at the point of contact 51 is represented as θ.

Rotation in a direction A shown in FIG. 3 is given to the tilt detector 10 with a straight line piercing through the center of the tilt detector 10 and parallel to the MY axis set as an axis of the rotation. In this case, the size of a rotation angle with respect to the gravity direction of the MX axis at the time when the conductive ball 15 rolls out onto the electrode 13 from a space between the electrode 12 and the electrode 13 is θ. From a state (not shown in the figure) in which the MX axis is parallel to the gravity direction and the electrode 13 is located in the gravity direction, rotation in a direction B shown in FIG. 3 is given to the tilt detector 10 with an axis piercing through the center of the tilt detector 10 and parallel to the MY axis set as an axis of the rotation. In this case, the size of a rotation angle at the time when the conductive ball 15 rolls into the space between the electrode 12 and the electrode 13 from the surface of the electrode 13 is (90°−Φ). In FIG. 3, when the section of the space 14 is a circle, the center point C1 is the center point of the space 14 and the curvature radius R is the radius of the space 14. In this case, the straight line M1 is identical with the straight line M2. As a distance between the electrode 12 and the electrode 13 is shorter, a difference between the sizes Φ and θ is smaller. As the length of the radius r of the conductive ball 15 is longer, the difference between the sizes Φ and θ is smaller.

In FIGS. 8A to 8C, three states of a tilt detector 40 including an electrode 42, an electrode 43, and a conductive ball 45 are shown. In FIG. 8A, the MX axis is perpendicular to the gravity direction. The conductive ball 45 is in contact with the electrode 42 and the electrode 43. The electrode 42 and the electrode 43 are in the conductive state. In FIG. 8B, the MX axis is rotated by an angle θ1 from the state shown in FIG. 8A in a direction in which the electrode 43 is located in the gravity direction with respect to the electrode 42. θ1 is an angle at the time when the conductive ball 45 rolls out from a space between the electrode 42 and the electrode 43. A state of the tilt of the tilt detector 40 at the time when the electrode 42 and the electrode 43 change from the conductive state to a non-conductive state is a state of a tilt shown in FIG. 8B. In FIG. 8C, the MX axis is rotated by an angle (90°−Φ1) in a direction opposite to that shown in FIG. 8B from a state (not shown) in which the MX axis is parallel to the gravity direction. (90°−Φ1) is an angle at the time when the conductive ball 45 rolls into the space between the electrode 42 and the electrode 43. A state of the tilt of the tilt detector 40 at the time when the electrode 42 and the electrode 43 change from the non-conductive state to the conductive state is a state of a tilt shown in FIG. 8C.

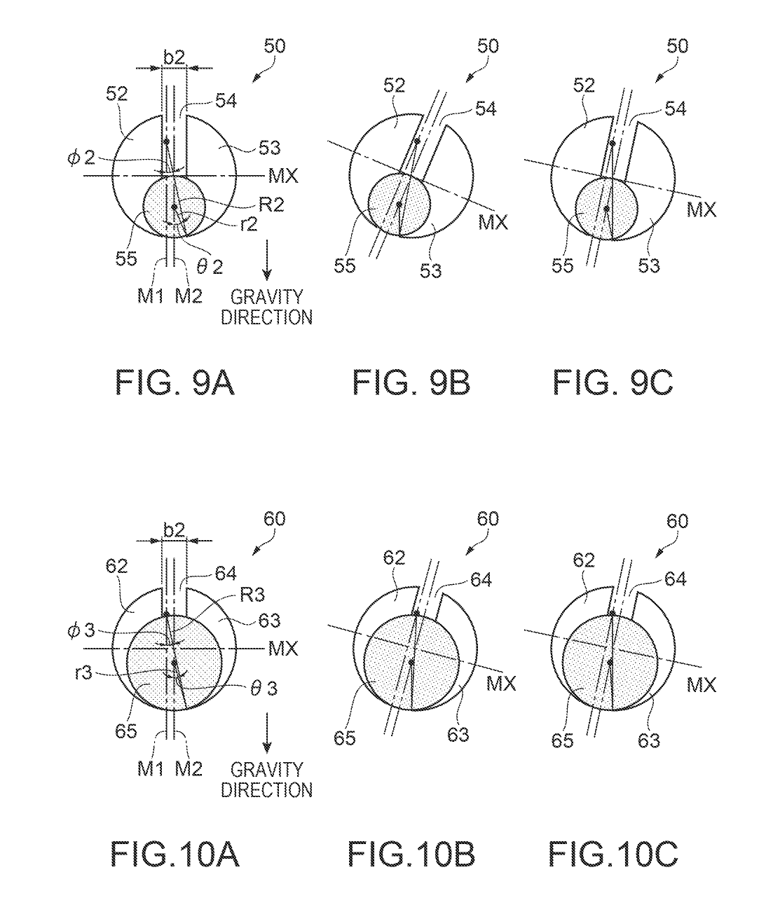

In FIGS. 9A to 9C, three states of a tilt detector 50 including an electrode 52, an electrode 53, and a conductive ball 55 are shown. A difference between the tilt detector 40 shown in FIGS. 8A to 8C and the tilt detector 50 is a difference in a distance between a pair of electrodes. A distance between the electrode 42 and the electrode 43 of the tilt detector 40 is b1 as shown in FIG. 8A, a distance between the electrode 52 and the electrode 53 of the tilt detector 50 is b2 as shown in FIG. 9A, and b1 is larger than b2. A radius r1 of the conductive ball 45 and a radius r2 of the conductive ball 55 are the same length. In FIG. 9A, the MX axis is perpendicular to the gravity direction. The conductive ball 55 is in contact with the electrode 52 and the electrode 53. The electrode 52 and the electrode 53 are in the conductive state. In FIG. 9B, the MX axis is rotated by an angle θ2 from the state shown in FIG. 9A in a direction in which the electrode 53 is located in the gravity direction with respect to the electrode 52. θ2 is an angle at the time when the conductive ball 55 rolls out from a space between the electrode 52 and the electrode 53. In other words, a state of the tilt of the tilt detector 50 at the time when the electrode 52 and the electrode 53 change from the conductive state to the non-conductive state is a state of a tilt shown in FIG. 9B. In FIG. 9C, the MX axis is rotated by an angle (90°−Φ2) in a direction opposite to that shown in FIG. 9B from a state (not shown) in which the MX axis is parallel to the gravity direction. (90°−Φ2) is an angle at the time when the conductive ball 55 rolls into the space between the electrode 52 and the electrode 53. In other words, a state of the tilt of the tilt detector 50 at the time when the electrode 52 and the electrode 53 change from the non-conductive state to the conductive state is a state of a tilt shown in FIG. 9C. As it is seen from comparison of FIGS. 8A to 8C and FIGS. 9A to 9C, when the distance between the pair of electrodes is shorter, a difference between a tilt amount with respect to the gravity direction of a tilt detector at the time when the pair of electrodes change from the conductive state to the non-conductive state and a tilt amount with respect to the gravity direction of the tilt detector at the time when the pair of electrodes change from the non-conductive state to the conductive state is smaller.

In FIGS. 10A to 10C, three states of a tilt detector 60 including an electrode 62, an electrode 63, and a conductive ball 65 are shown. A difference between the tilt detector 50 shown in FIGS. 9A to 9C and the tilt detector 60 is a difference in the radius of a conductive ball. As it is seen from FIG. 9A and FIG. 10A, a radius r2 of the conductive ball 55 and a radius r3 of the conductive ball 65 are in a relation of r2<r3. In FIG. 10A, the MX axis is perpendicular to the gravity direction. The conductive ball 65 is in contact with the electrode 62 and the electrode 63. The electrode 62 and the electrode 63 are in the conductive state. In FIG. 10B, the MX axis is rotated by an angle θ3 from the state shown in FIG. 10A in a direction in which the electrode 63 is located in the gravity direction with respect to the electrode 62. θ3 is an angle at the time when the conductive ball 65 rolls out from a space between the electrode 62 and the electrode 63. In other words, a state of the tilt of the tilt detector 60 at the time when the electrode 62 and the electrode 63 change from the conductive state to the non-conductive state is a state of a tilt shown in FIG. 10B. In FIG. 10C, the MX axis is rotated by an angle (90°−Φ3) in a direction opposite to that shown in FIG. 10B from a state (not shown) in which the MX axis is parallel to the gravity direction. (90°−Φ3) is an angle at the time when the conductive ball 65 rolls into the space between the electrode 62 and the electrode 63. In other words, a state of the tilt of the tilt detector 60 at the time when the electrode 62 and the electrode 63 change from the non-conductive state to the conductive state is a state of a tilt shown in FIG. 10C. As it is seen from comparison of FIGS. 9A to 9C and FIGS. 10A to 10C, when the diameter of the conductive ball is longer, a difference between a tilt amount with respect to the gravity direction of a tilt detector at the time when the pair of electrodes change from the conductive state to the non-conductive state and a tilt amount with respect to the gravity direction of the tilt detector at the time when the pair of electrodes change from the non-conductive state to the conductive state is smaller.

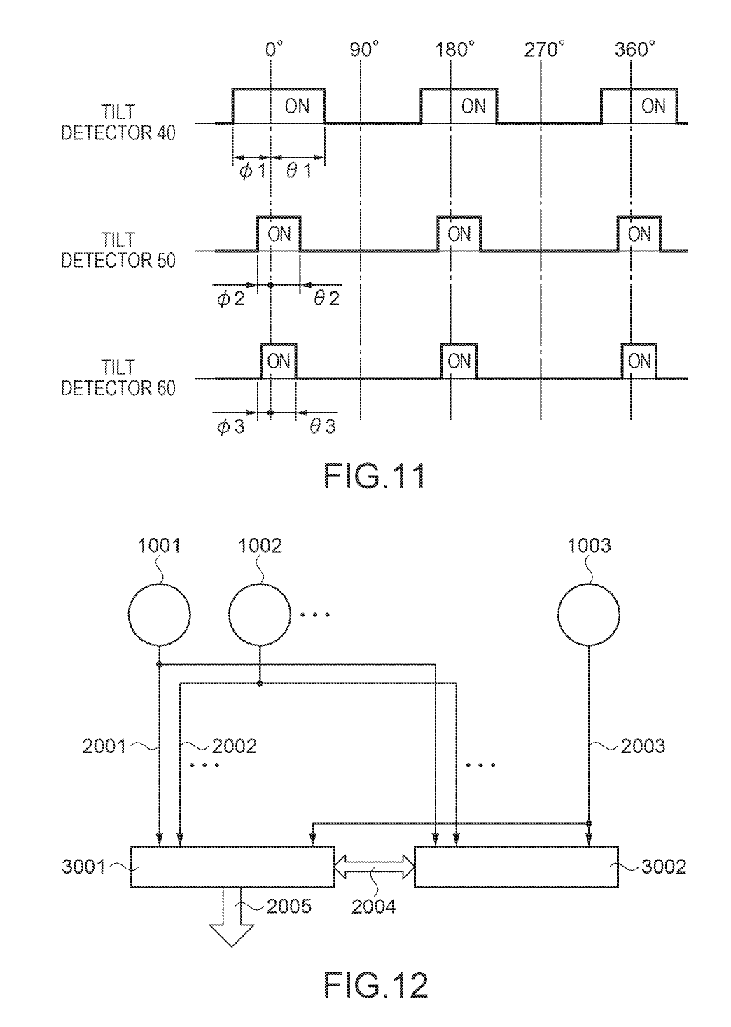

In FIG. 11, images of the conductive state (indicated by ON) and the non-conductive state with respect to rotation angles are shown concerning the respective tilt detectors 40, 50, and 60. In FIG. 11, portions marked ON are portions indicating the conductive state.

The operation of the motion sensor 1 is explained. The conductive balls 15, 25, and 35 respectively move in the spaces 14, 24, and 34, in which the conductive balls 15, 25, and 35 are present, with the gravity, inertia force, and reaction due to impact given to the motion sensor 1. However, basically, the conductive balls 15, 25, and 35 tend to be located in the gravity direction. Therefore, in a state in which the motion sensor 1 is at a standstill and the directions of the MZ axis and the Z axis coincide with each other (a state shown in FIG. 1), the conductive ball 15 of the tilt detector 10 is in contact with both the electrode 12 and the electrode 13 and the electrode 12 and the electrode 13 are in the conductive state (a state shown in FIG. 4B). The conductive ball 25 of the tilt detector 20 is in contact with both the electrode 22 and the electrode 23 and the electrode 22 and the electrode 23 are in the conductive state (the state shown in FIG. 4B). The conductive ball 35 of the tilt detector 30 is in contact with only the electrode 32 present in the gravity direction and the electrode 32 and the electrode 33 are in the non-conductive state (a state shown in FIG. 4A).

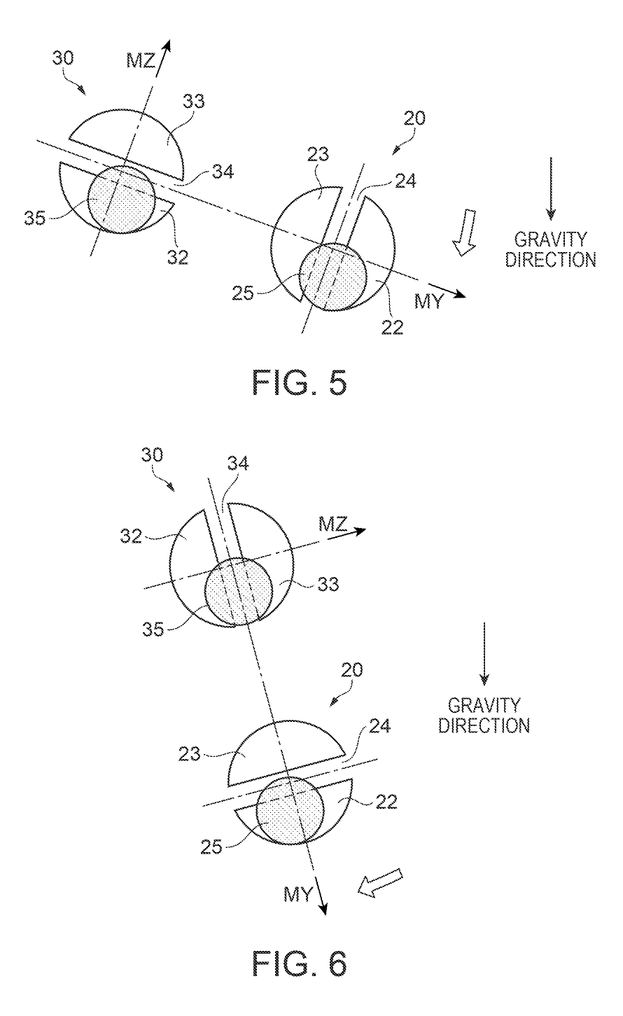

FIGS. 5 and 6 are diagrams showing states of the tilt detector 20 and the tilt detector 30 at the time when the motion sensor 1 is rotated by a predetermined angle with the MX axis as an axis of rotation from the state shown in FIG. 1. FIG. 5 is a diagram showing a state around the time when the electrode 22 and the electrode 23 change from the conductive state to the non-conductive state in the tilt detector 20. FIG. 6 is a diagram showing a state around the time when the motion sensor 1 is further rotated from the state shown in FIG. 5 and the electrode 32 and the electrode 33 change from the non-conductive state to the conductive state in the tilt detector 30. The change from the conductive state to the non-conductive state in the tilt detector 20 and the change from the non-conductive state to the conductive state in the tilt detector 30 are transmitted as an output signal from the motion sensor 1. It is possible to learn from the output signal that rotation from “an angle at which the conductive ball 25 starts to roll out from the space between the electrode 22 and the electrode 23” to “an angle at which the conductive ball 35 starts to roll into the space between the electrode 32 and the electrode 33” occurs in the motion sensor 1 with the MX axis as an axis of rotation.

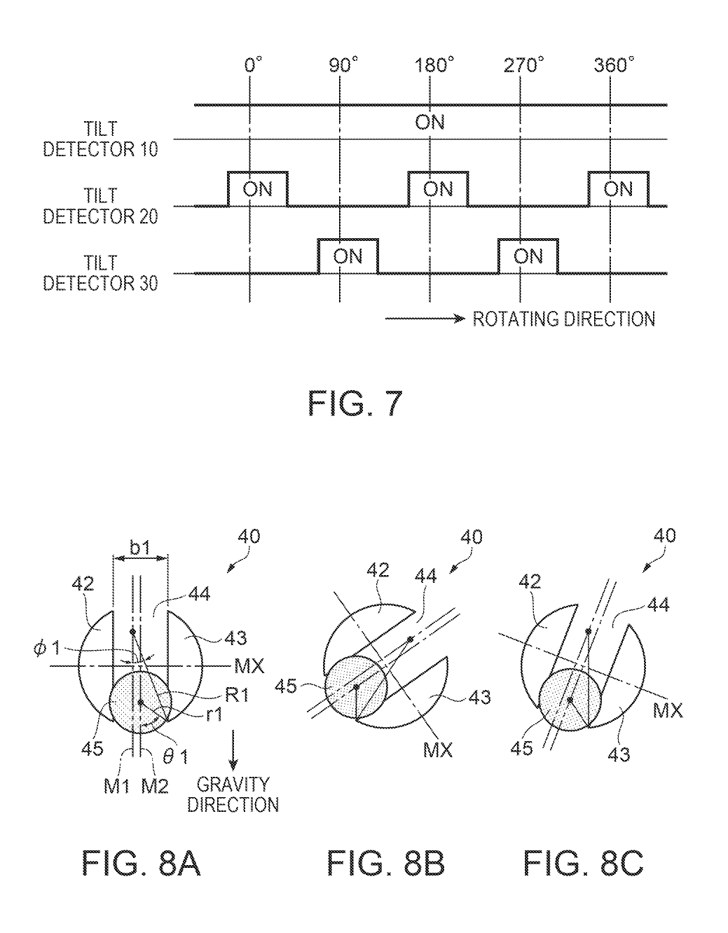

Although not shown in FIGS. 5 and 6, the electrode 12 and the electrode 13 in the tilt detector 10 are always in the conductive state in a state in which the motion sensor 1 is rotated with the MX axis as an axis of rotation. FIG. 7 is a diagram showing an example of a change of the conductive state (indicated by ON) and the non-conductive state of the tilt detectors 10, 20, and 30 at the time when the motion sensor 1 is rotated with the MX axis as an axis of rotation. A state of this change is a state detected when the motion sensor 1 is rotated with the MX axis as an axis of rotation.

### Second Embodiment

This embodiment is an example of a motion sensor including four or more tilt detectors. FIG. 12 is a schematic block diagram of a motion sensor 2. As shown in FIG. 12, main components of the motion sensor 2 are n tilt detectors (tilt detectors 1001, 1002, etc.), a control unit 3001, and a storing unit 3002. Three tilt detectors among the n tilt detectors are set in a direction same as the direction of the tilt detectors 10, 20, and 30 explained in the first embodiment. The other tilt detectors are set in a direction different from the direction of the tilt detectors 10, 20, and 30. Output signals 2001, 2002, and the like of the tilt detectors 1001, 1002, and the like are input to the control unit 3001 and the storing unit 3002. The control unit 3001 and the storing unit 3002 are connected by a bus 2004. The control unit 3001 has a function of communicating with a host apparatus. The control unit 3001 and the host apparatus are connected by an external connection signal line 2005. The external connection signal line 2005 includes a signal line necessary for communication with the host apparatus and a signal line for outputting measurement values of the motion sensor 2 to the outside.

The motion sensor 2 outputs, using the external connection signal line 2005, the measurement values of the motion sensor 2 as values of the output signals 2001, 2002, and the like or predetermined measurement values calculated on the basis of the output signals 2001, 2002, and the like. The predetermined measurement values are tilt angles of the respective MX, MY, and MZ axes with respect to the X, Y, and Z axes at the time when the Z axis is set in parallel to the gravity direction. The control unit 3001 monitors states of the output signals 2001, 2002, and the like and calculates the predetermined measurement values. The control unit 3001 writes the predetermined measurement values in the storing unit 3002 via the bus 2004. This makes it possible to leave a history of the predetermined measurement values.

The storing unit 3002 can store the values of the output signals 2001, 2002, and the like. The storing unit 3002 includes a storage mode register (not shown) that sets a signal to be stored. When the control unit 3001 writes a predetermined value in the storage mode register via the bus 2004, a signal to be stored in the storing unit 3002 is designated. For example, first, the storage mode register is set to store the value of the output signal 2001 and, thereafter, set to store the values of the output signals 2001, 2002, and the like when a change in the value of the output signal 2001 is detected. This makes it possible to reduce the number of signals stored in a state in which there is no change in the output signal 2001 and effectively use a storage capacity of the storing unit 3002. In this way, the control unit 3001 monitors the output signal 2001 and rewrites the values of the storage mode registers according to a change in the output signal 2001. This makes it possible to dynamically change a type of a signal to be stored while effectively using the storage capacity of the storing unit 3002.

What kind of control applied to the storing unit 3002 by the control unit 3001 may be set in the control unit 3001 in advance according to a measurement purpose of the motion sensor 2. A procedure of control performed by the control unit 3001 may be set from the host apparatus via the external connection signal line 2005. In any case, the motion sensor 2 can leave a history in the storing unit 3002 tanking into account the motion of a measurement target to which the motion sensor 2 is attached. The embodiments of the invention have been explained. However, the invention is not limited to the embodiments explained above. For example, it is also possible that the output signals 2001, 2002, and the like are output to the host apparatus and the host apparatus performs control of the storing unit 3002.

The entire disclosure of Japanese Patent Application No. 2009-277255, filed Dec. 7, 2009 is expressly incorporated by reference herein.

What is claimed is:

1. A motion sensor comprising:
a first tilt detector including a first electrode having a recess and a second electrode and a first conductive ball having shape same as that of the first electrode;
a second tilt detector including a third electrode having a recess and a fourth electrode and a second conductive ball having shape same as that of the third electrode; and
a third tilt detector including a fifth electrode having a recess and a sixth electrode and a third conductive ball having shape same as that of the fifth electrode, wherein
in the first tilt detector, the recess of the first electrode and the recess of the second electrode are opposed to each other, the first electrode and the second electrode are arranged to be plane-symmetrical to each other at a first distance with respect to a plane perpendicular to a first axis, and the first conductive ball moves in a space between the first electrode and the second electrode to change the first electrode and the second electrode to a conductive state or a non-conductive state,
in the second tilt detector, the recess of the third electrode and the recess of the fourth electrode are opposed to each other, the third electrode and the fourth electrode are arranged to be plane-symmetrical to each other at a second distance with respect to a plane perpendicular to a second axis orthogonal to the first axis, and the second conductive ball moves in a space between the third electrode and the fourth electrode to change the third electrode and the fourth electrode to the conductive state and the non-conductive state,
in the third tilt detector, the recess of the fifth electrode and the recess of the sixth electrode are opposed to each other, the fifth electrode and the sixth electrode are arranged to be plane-symmetrical to each other at a third distance with respect to a plane perpendicular to a third axis orthogonal to both the first axis and the second axis, and the third conductive ball moves in a space between the fifth electrode and the sixth electrode to change the fifth electrode and the sixth electrode to the conductive state or the non-conductive state,
the first distance is a distance shorter than a diameter of the first conductive ball,
the second distance is a distance shorter than a diameter of the second conductive ball, and
the third distance is a distance shorter than a diameter of the third conductive ball.

2. The motion sensor according to claim 1, wherein
at least one fourth tilt detector is arranged on the first axis or an axis parallel to the first axis,
at least one fifth tilt detector is arranged on the second axis or an axis parallel to the second axis,
at least one sixth tilt detector is arranged on the third axis or an axis parallel to the third axis,
the fourth tilt detector includes a seventh electrode having a recess and an eighth electrode and a fourth conductive ball having shape same as that of the seventh electrode, the recess of the seventh electrode and the recess of the eighth electrode are opposed to each other, the seventh electrode and the eighth electrode are arranged to be plane-symmetrical to each other at a fourth distance with respect to one plane among arbitrary planes other than the plane perpendicular to the first axis, and the fourth conductive ball moves in a space between the seventh electrode and the eighth electrode to change the seventh electrode and the eighth electrode to the conductive state or the non-conductive state,
the fifth tilt detector includes a ninth electrode having a recess and a tenth electrode and a fifth conductive ball having shape same as that of the ninth electrode, the recess of the ninth electrode and the recess of the tenth electrode are opposed to each other, the ninth electrode and the tenth electrode are arranged to be plane-symmetrical to each other at a fifth distance with respect to one plane among arbitrary planes other than the plane perpendicular to the second axis orthogonal to the first axis, and the fifth conductive ball moves in a space between the ninth electrode and the tenth electrode to change the ninth electrode and the tenth electrode to the conductive state or the non-conductive state,
the sixth tilt detector includes an eleventh electrode having a recess and a twelfth electrode and a sixth conductive ball having shape same as that of the eleventh electrode, the recess of the eleventh electrode and the recess of the twelfth electrode are opposed to each other, the eleventh electrode and the twelfth electrode are arranged to be plane-symmetrical to each other at a sixth distance with respect to one plane among arbitrary planes other than the plane perpendicular to the third axis orthogonal to both the first axis and the second axis, and the sixth conductive ball moves in a space between the eleventh electrode and the twelfth electrode to change the eleventh electrode and the twelfth electrode to the conductive state or the non-conductive state,
the fourth distance is a distance shorter than the diameter of the fourth conductive ball,
the fifth distance is a distance shorter than the diameter of the fifth conductive ball, and
the sixth distance is a distance shorter than the diameter of the sixth conductive ball.

3. The motion sensor according to claim 2, wherein at least two of the first tilt detector, the second tilt detector, the third tilt detector, the fourth tilt detector, the fifth tilt detector, and the sixth tilt detector are stored in a cylindrical container.

4. The motion sensor according to claim 2, wherein a history of output signals of at least one of the first tilt detector, the second tilt detector, the third tilt detector, the fourth tilt detector, the fifth tilt detector, and the sixth tilt detector is stored.

5. The motion sensor according to claim 4, wherein, as the history, when the output signals reach a predetermined value, a history of output signals of the first tilt detector, the second tilt detector, the third tilt detector, the fourth tilt detector, the fifth tilt detector, and the sixth tilt detector is stored.
